(19) United States
(12) Patent Application Publication
(10) Pub. No.: US 2006/0032517 A1
(43) Pub. Date: Feb. 16, 2006

(54) Apparatus and method for monitoring a process of wet cleaning

(75) Inventors: Chen Kvan-Ming, Kaohsiung City (TW); Wu Mu-Jung, Hsinchu City (TW); Jen Chen-Kuo, Sindian City (TW); Ku Jin-Shan, Jhudong Township (TW); Chen Chi-Tsan, Hsinchu City (TW)

Correspondence Address: BRUCE H. TROXELL, SUITE 1404, 5205 LEESBURG PIKE, FALLS CHURCH, VA, 22041, US

(73) Assignee: PSC Powerchip Semiconductor Corp.

(21) Appl. No.: 11/023,558

(22) Filed: Dec. 29, 2004

(30) Foreign Application Priority Data
Aug. 10, 2004 (TW) 93123852

(51) Int. Cl. B08B 7/00; B08B 7/04

(52) U.S. Cl. 134/6; 134/18; 134/56 R

(57) ABSTRACT

The present invention provides an apparatus for monitoring a process of wet cleaning, being applied in a wet scrubber having at least a brush arm and at least a fluid supply for providing a fluid to soak an object to be cleaned (e.g. wafer), the apparatus of the invention comprising: a position sensor, coupled to the brush arm; and at least a flow-meter sensor, coupled to the fluid supply; wherein the position sensor is activated while the brush arm is proceeding with a cleaning procedure, and the flow-meter sensor is activated for monitoring the fluid supply while the position sensor is activated. Moreover, the flow-meter sensor further comprises a transmitting end, a receiving end and a floating unit, wherein the receiving end is arranged at a position with respect to the transmitting end for receiving signals transmitted from the transmitting end, and the floating unit is disposed between the receiving end and the transmitting end and is able to change its positioning with respect to the variation of the flow rate of the fluid. In this regard, when the flow rate is insufficient, the floating unit is positioned at a location blocking the signal transmitted from the transmitting end such that the receiving end can not receives signals from the transmitting end.

### 1. FIELD OF THE INVENTION

The present invention relates to an apparatus and method of monitoring, and more particularly, to an apparatus and method for monitoring flow rate in a wet cleaning process.

### 2. BACKGROUND OF THE INVENTION

While using a conventional wafer scrubber for cleaning a wafer, brushes are controlled by brush arms for proceeding with wafer cleaning operation and flow-meter sensors are used for monitoring the flow rate of rinsing water. However, during the cleaning process, there is no alarm system existed in the conventional scrubber for alerting the situation of no sufficient flow for flooding the wafer. As the consequence, the cleaning process will continue with no sufficient flow that causes the dry-brushed wafer to defect and thus increase the manufacturing cost. Moreover, if the wafer with excess particles or defects existed on the surface thereof is not detected after the cleaning process by on-line quality control and the defected wafer is being send to the posterior processes, the whole production batch will be ruined such that not only it is wasting time and man power, but also wasting the materials used in the manufacturing process.

In view of the above description, the conventional scrubber at least has the following shortcomings:
(a) While using a convention scrubber, there is no alarm system for monitoring the flow rate of rinsing water that constitutes a sever defect in the automatic on-line quality control.
(b) The wafer cleaning method of the conventional scrubber requires an additional operation of wafer inspection after completing the cleaning operation so as to ensure the particles or defects existed on wafer surface are within a predefined range, that the additional wafer inspection increases the overall procedures required for the wafer production and thus reduce the throughput.
(c) It is likely for a conventional scrubber to overlook that the particles or defects existed on wafer surface are already exceeding the predefined range. When the defected wafer is being send to the posterior processes, the whole production batch will be ruined or the yield will be reduce. As the consequence, not only time and man power are wasted, but also the materials used in the manufacturing process are wasted, that causes the increase of manufacturing cost to increase and the reduction of market competitiveness.

### SUMMARY OF THE INVENTION

It is the primary object of the invention to provide an apparatus and method for monitoring a process of wet cleaning, which is capable of effectively monitoring the status a scrubber while the same is performing wafer cleaning procedure. That is, the apparatus and method provided in the present invention enables the alarm signal to be issued while detecting an abnormal flow rate of rinsing water, such that the flow rate of rinsing water is ensured to be kept within a predefined range so as to maintain a smooth automated production line.

Another object of the invention is to provide an apparatus and method for monitoring a process of wet cleaning, which can ensure the cleanness of a wafer surface after the scrubber had completed the cleaning process on the same without the requirement of performing an additional wafer inspection procedure, such that the implementation of the present invention can improve production throughput.

It is yet another object of the invention is to provide an apparatus and method for monitoring a process of wet cleaning, which can ensure the process to have a preferred yield, such that the consumption of wafer is reduced, and as the consequence, the overall manufacturing cost is reduced and the market competitiveness is enhanced.

Further, another object of the invention is to provide an apparatus and method for monitoring a process of wet cleaning, by which the surface of a wafer is ensured to be sufficiently cleaned for increasing the yield of the posterior process and avoiding the production of defected products, such that the consumption of man power and material can be reduced so as to raise market competitiveness.

To achieve the above object, the present invention provides an apparatus for monitoring a process of wet cleaning, being applied in a wet scrubber having at least a brush arm and at least a fluid supply for providing a fluid to soak an object to be cleaned (e.g. wafer), the apparatus of the invention comprising: a position sensor, coupled to the brush arm; and at least a flow-meter sensor, coupled to the fluid supply; wherein the position sensor is activated while the brush arm is proceeding with a cleaning procedure, and the flow-meter sensor is activated for monitoring the fluid supply while the position sensor is activated. Moreover, the flow-meter sensor further comprises a transmitting end, a receiving end and a floating unit, wherein the receiving end is arranged at a position with respect to the transmitting end for receiving signals transmitted from the transmitting end, and the floating unit is disposed between the receiving end and the transmitting end and is able to change its positioning with respect to the variation of the flow rate of the fluid. In this regard, when the flow rate is insufficient, the floating unit is positioned at a location blocking the signal transmitted from the transmitting end such that the receiving end can not receives signals from the transmitting end.

Generally, the sensing system adopted by the position sensor and the flow-meter sensor can be a system selected from the group consisting of Infrared ray sensing, laser sensing, or other common method known to those person skilled in the art.

To achieve the above object, the present invention provides a method for monitoring a process of wet cleaning, being applied in a wet scrubber having at least a brush arm and at least a fluid supply for providing a fluid, the method comprising the steps of:
providing a flow-meter sensor in the scrubber, wherein the flow-meter at least comprises:
   a transmitting end;
   a receiving end, arranged at a position with respect to the transmitting end for receiving signals transmitted from the transmitting end; and
   a floating unit, disposed between the receiving end and the transmitting end and being able to change its positioning with respect to the flow rate variation the fluid;
coupling the flow-meter sensor to a fluid supply;
proceeding with the wet cleaning process by using the brush arm to clean an object (e.g. a wafer) and the fluid supply to provide the fluid for soaking the object;
activating the flow-meter sensor to detect the flow rate of the fluid while proceeding with the cleaning process;
issuing an alarm signal by the flow-meter sensor while the receiving end of the flow-meter sensor is blocked from receiving signals transmitted from the transmitting end of the flow-meter sensor since an insufficient flow rate is detected.

In addition, the method further comprises:
stopping the action of the scrubber while the receiving end of the flow-meter sensor is blocked from receiving signals transmitted from the transmitting end of the flow-meter sensor.

### BRIEF DESCRIPTION OF THE DRAWINGS

FIG. 1 is a schematic illustration showing an apparatus for monitoring a process of wet cleaning according to a preferred embodiment of the invention.

FIG. 2A is a schematic diagram depicting the state of the flow-meter sensor as a normal flow rate is detected by the same according to a preferred embodiment of the invention.

FIG. 2B is a schematic diagram depicting the state of the flow-meter sensor as an abnormal flow rate is detected by the same according to a preferred embodiment of the invention.

FIG. 3 is a circuit layout of the apparatus for monitoring a process of wet cleaning according to a preferred embodiment of the invention.

FIG. 4 is a flow chart of the method for monitoring a process of wet cleaning according to a preferred embodiment of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

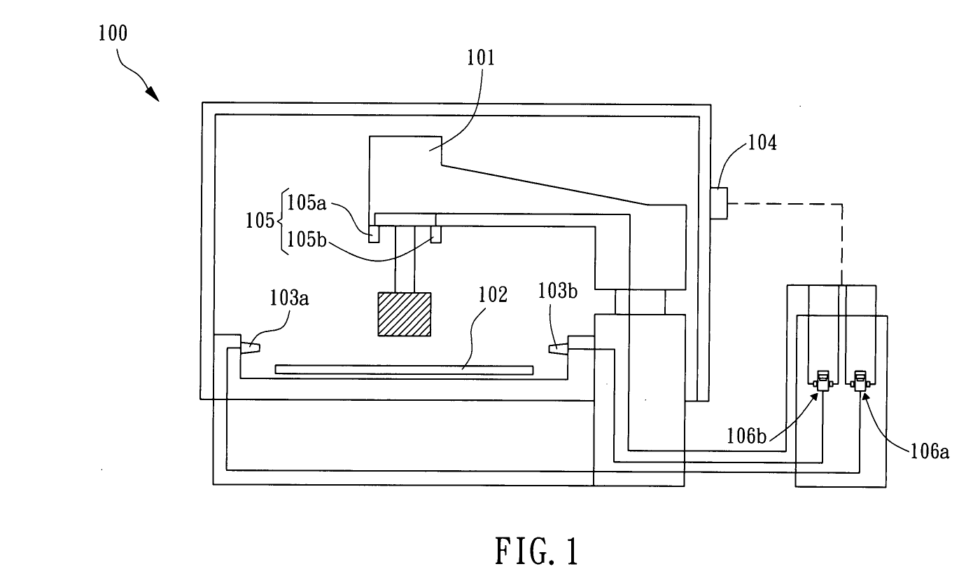

Please refer to FIG. 1, which is a schematic illustration showing an apparatus for monitoring a process of wet cleaning according to a preferred embodiment of the invention. As seen in FIG. 1, a wet scrubber 100 is used for providing fluid (not shown) to flood the surface of an object to be cleaned (e.g. a wafer 102) during a cleaning process. The monitoring apparatus of the invention is primarily being applied in a wet scrubber 100 having at least a brush arm 101 and two fluid supply 103a, 103b, for providing a fluid to soak an object to be cleaned, such as a wafer 102, and the monitoring apparatus of the invention at least comprises: a position sensor 105, coupled to the brush arm 101; and two flow-meter sensor 106a, 106b, respectively coupled to the fluid supplies 103a, 103b; wherein the position sensor 105 is activated while the brush arm 101 is proceeding with a cleaning procedure on the wafer 102, and the flow-meter sensor 106a, 106b are activated for monitoring the fluid supplies 103a, 103b while the position sensor 105 is activated. When at least one of the two flow-meter sensor 106a, 106b detects an abnormal flow rate from the corresponding flow supply, the sensor that detect abnormal will issue an alarm signal to a detector 104 for enabling the scrubber 100 to stop operating.

Generally, the position sensor 105 is composed of a receiving end 105a and a transmitting end 105b, and the sensing system adopted by the position sensor 105 can be a system selected from the group consisting of Infrared ray sensing, laser sensing, or other common method known to those person skilled in the art for sensing the cleaning action of the brush arm 101.

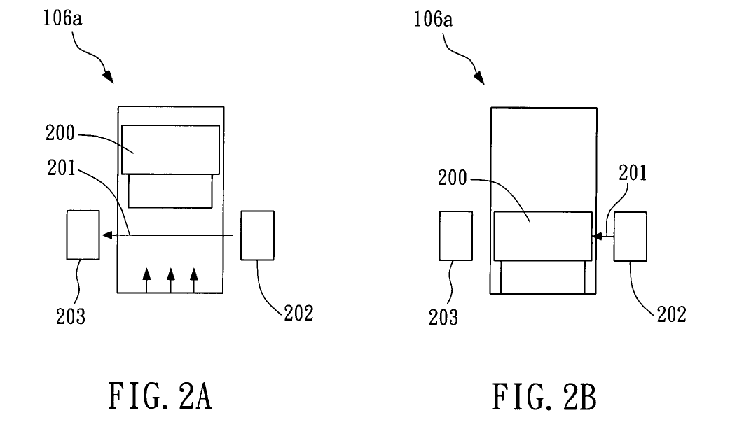

Please refer to FIG. 2A and FIG. 2B, which respectively is a schematic diagram depicting the state of the flow-meter sensor as a normal flow rate is detected by the same and a schematic diagram depicting the state of the flow-meter sensor as an abnormal flow rate is detected by the same. As seen in FIG. 2A, the flow-meter sensor 106a at least comprises a transmitting end 202, a receiving end 203 and a floating unit 200, wherein the receiving end 203 is arranged at a position with respect to the transmitting end 202 for receiving a signal 201 transmitted from the transmitting end 202, and the floating unit 200 is disposed between the receiving end 203 and the transmitting end 202 and is able to change its positioning with respect to the variation of the flow rate of the fluid. In this regard, when the flow rate is sufficient, that is, normal, the floating unit 200 is positioned at a location away from blocking the signal 201 such that the receiving end 203 can receives the signal 201 from the transmitting end 202. However, as seen in FIG. 2B, when the flow rate is insufficient, that is, abnormal, the floating unit 200 is positioned at a location blocking the signal 201 such that the receiving end 203 can not receives the signal 201 from the transmitting end 202, and thus the flow-meter sensor will issue an alarm signal enabling the scrubber 100 to stop operating. The activation of the sensor 106b is similar to that of the sensor 106a and is not described further hereinafter. Moreover, it is common that the sensing system adopted by the both the flow-rate sensors 106a, 106b can be a system selected from the group consisting of Infrared ray sensing, laser sensing, or other common method known to those person skilled in the art.

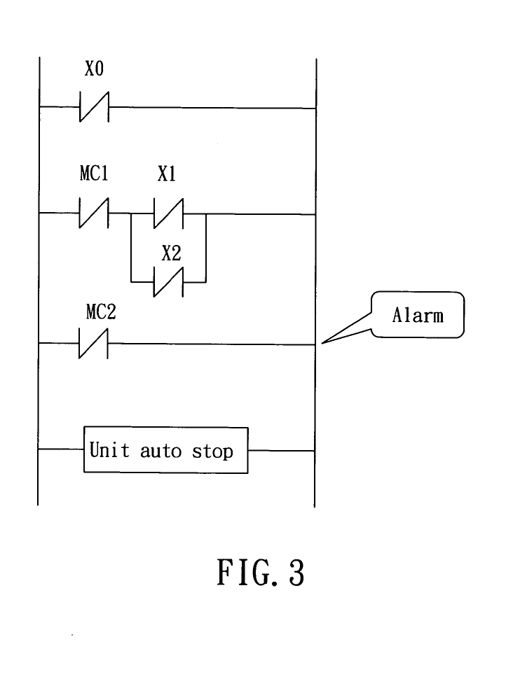

Please refer to FIG. 3, which is a circuit layout of the apparatus for monitoring a process of wet cleaning according to a preferred embodiment of the invention. When the brush arm is lowered to a position for performing a cleaning procedure on a wafer, the position sensor (X0) is activated to drive the fluid supply for providing fluid (MC1) while the flow-rate sensor (X1) and the flow-rate sensor (X2) monitor the flow rate in real time. As any one of the two flow-rate sensors detects an abnormal flow rate, the sensor that detect abnormal will send an signal drive the detector (MC2) for issuing a cover interlock alarm to stop the operation of the scrubber.

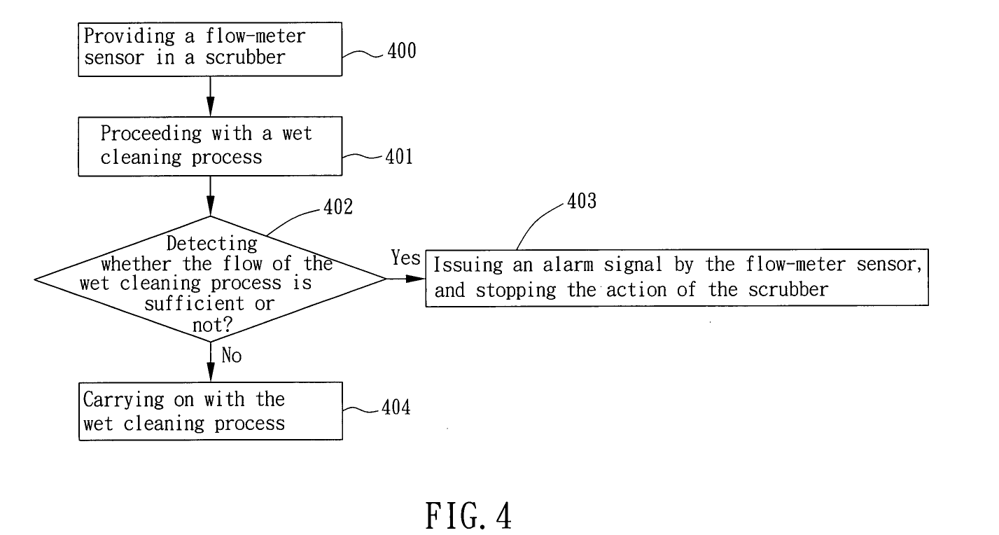

Please refer to FIG. 4, which is a flow chart of the method for monitoring a process of wet cleaning according to a preferred embodiment of the invention. The method for monitoring a process of wet cleaning, being applied in a wet scrubber having at least a brush arm and at least a fluid supply for providing a fluid, the method comprising the steps of:
step 400: providing a flow-meter sensor in the scrubber and coupling the flow-meter sensor to a fluid supply,
   wherein the flow-meter at least comprises:
   a transmitting end;
   a receiving end, arranged at a position with respect to the transmitting end for receiving signals transmitted from the transmitting end; and
   a floating unit, disposed between the receiving end and the transmitting end and being able to change its positioning with respect to the flow rate variation the fluid;
step 401: proceeding with the wet cleaning process by using the brush arm to clean the surface of a wafer and rinsing the wafer surface by the fluid provided by the fluid supply;
step 402: detecting whether the flow rate of the wet cleaning process is normal or not, that is, activating the flow-meter sensor to detect the flow rate of the fluid while proceeding with the cleaning process;
step 403: issuing an alarm signal by the flow-meter sensor and stopping the action of the scrubber while the receiving end of the flow-meter sensor is blocked from receiving signals transmitted from the transmitting end of the flow-meter sensor.
step 404: carrying on with the wet cleaning process while the flow rate is normal.

To sum up, the apparatus and method for monitoring a process of wet cleaning is capable of effectively monitoring the status a scrubber while the same is performing wafer cleaning procedure, and also issuing an alarm signal while detecting an abnormal flow rate of rinsing water for stopping the action of the scrubber, such that it can ensure the cleanness of a wafer surface after the scrubber had completed the cleaning process on the same without the requirement of performing an additional wafer inspection procedure, and thus it can ensure the process to have a preferred yield enabling the consumption of wafer to be reduced, and as the consequence, the overall manufacturing cost is reduced and the market competitiveness is enhanced.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An apparatus for monitoring a process of wet cleaning, being applied in a wet scrubber having at least a brush arm for cleaning an object and at least a fluid supply for providing a fluid to soak the object, the apparatus comprising:
a position sensor, coupled to the brush arm; and
at least a flow-meter sensor, coupled to the fluid supply, further comprising:
a transmitting end;
a receiving end; and
a floating unit
wherein, the position sensor is activated while the brush arm is proceeding with a cleaning procedure, and the flow-meter sensor is activated for monitoring the fluid supply while the position sensor is activated, and the receiving end is arranged at a position with respect to the transmitting end for receiving signals transmitted from the transmitting end, and the floating unit is disposed between the receiving end and the transmitting end and is able to change its positioning with respect to the variation of the flow rate of the fluid so that when the flow rate is insufficient, the floating unit is positioned at a location blocking the signal transmitted from the transmitting end to the receiving end.

2. The apparatus as recited in claim 1, wherein the position sensor is substantially an infrared ray sensor.

3. The apparatus as recited in claim 1, wherein the position sensor is substantially a laser sensor.

4. The apparatus as recited in claim 1, wherein the flow-meter sensor is substantially an infrared ray sensor.

5. The apparatus as recited in claim 1, wherein the flow-meter sensor is substantially a laser sensor.

6. A method for monitoring a process of wet cleaning, being applied in a wet scrubber having at least a brush arm and at least a fluid supply for providing a fluid, the method comprising:
providing a flow-meter sensor in the scrubber and coupling the flow-meter sensor to a fluid supply,
wherein the flow-meter at least comprises:
a transmitting end;
a receiving end, arranged at a position with respect to the transmitting end for receiving a signal transmitted from the transmitting end; and
a floating unit, disposed between the receiving end and the transmitting end and being able to change its positioning with respect to the variation of flow rate of the fluid;
proceeding with the wet cleaning process by using the brush arm to clean an object and using the fluid supply to provide the fluid for soaking the object;
activating the flow-meter sensor to detect the flow rate of the fluid while proceeding with the cleaning process; and
issuing an alarm signal by the flow-meter sensor while the receiving end of the flow-meter sensor is blocked from receiving the signal transmitted from the transmitting end of the flow-meter sensor as the flow rate is insufficient.

7. The method as recited in claim 6, wherein the method further comprising:
stopping the action of the scrubber while the receiving end of the flow-meter sensor is blocked from receiving the signal transmitted from the transmitting end of the flow-meter sensor.

8. The method as recited in claim 6, wherein the position sensor is substantially an infrared ray sensor.

9. The method as recited in claim 6, wherein he position sensor is substantially a laser sensor.

10. A wet scrubber, being used for providing a fluid to soak the surface of an object to be cleaned in a process of wet cleaning, the scrubber comprising:
a fluid supply, for providing the fluid; and
a flow-meter sensor, coupled to the fluid supply, capable of detecting the status of flow while the fluid is flooding the surface of the object, the flow-meter sensor further comprising:
a transmitting end;
a receiving end; and
a floating unit
wherein, the receiving end is arranged at a position with respect to the transmitting end for receiving signals transmitted from the transmitting end, and the floating unit is disposed between the receiving end and the transmitting end and is able to change its positioning with respect to the variation of the flow rate of the fluid so that when the flow rate is insufficient, the floating unit is positioned at a location blocking a signal transmitted from the transmitting end to the receiving end.

11. The apparatus as recited in claim 10, wherein the flow-meter sensor is substantially an infrared ray sensor.

12. The apparatus as recited in claim 10, wherein the flow-meter sensor is substantially a laser sensor.
